(19) United States
(12) Patent Application Publication
(10) Pub. No.: US 2025/0144728 A1
(43) Pub. Date: May 8, 2025

(54) CIRCULAR SAW PLUNGE PIPE CUTTER

(71) Applicant: MILWAUKEE ELECTRIC TOOL CORPORATION, Brookfield, WI (US)

(72) Inventors: William R. Schlosser, Colgate, WI (US); Matthew R. Wolf, Wauwatosa, WI (US); Jacob K. Lindsey, Milwaukee, WI (US); Justin Miller, Richfield, WI (US); Joseph J. Pechstein, West Bend, WI (US); Keegan P. Fager, Waukesha, WI (US)

(21) Appl. No.: 18/934,326

(22) Filed: Nov. 1, 2024

Related U.S. Application Data
(60) Provisional application No. 63/596,826, filed on Nov. 7, 2023.

(51) Int. Cl. B23D 45/00; B23D 45/16; B23D 47/12

(52) U.S. Cl. CPC B23D 45/006; B23D 45/16; B23D 47/12

(57) ABSTRACT

A circular saw plunge pipe cutter includes a main housing, a drive mechanism at least partially disposed within the main housing, a saw blade operably coupled with the drive mechanism, and a shoe slidably coupled to the main housing. The shoe includes a pipe receptacle in which a pipe is receivable. The circular saw plunge pipe cutter is adjustable between a plunge state, in which the main housing moves toward the shoe and the saw blade extends into the pipe receptacle, and a retracted state in which the main housing moves away from the shoe and the saw blade does not extend into the pipe receptacle.

### CROSS-REFERENCE TO RELATED APPLICATIONS

This application claims priority to U.S. Provisional Patent Application No. 63/596,826 filed on Nov. 7, 2023, the entire content of which is incorporated herein by reference.

### FIELD OF THE DISCLOSURE

The present disclosure relates to pipe cutters, and more particularly to circular saw plunge pipe cutters.

### BACKGROUND OF THE DISCLOSURE

Oftentimes, during a remodel or retrofit of a house, office building, etc., it is necessary to cut a water pipe in situ. This can be difficult at best. As such, the construction industry is always seeking new tools that can improve worker efficiency and job safety.

### SUMMARY OF THE DISCLOSURE

The present disclosure provides, in a particular aspect, a circular saw plunge pipe cutter that includes a main housing, a drive mechanism at least partially disposed within the main housing, a saw blade operably coupled with the drive mechanism, and a shoe slidably coupled to the main housing that includes a pipe receptacle in which a pipe is receivable. The circular saw plunge pipe cutter is adjustable between a plunge state in which the main housing moves toward the shoe and the saw blade extends into the pipe receptacle, and a retracted state in which the main housing moves away from the shoe and the saw blade does not extend into the pipe receptacle.

The present disclosure provides, in another aspect, a circular saw plunge pipe cutter that includes a main housing having a guide plate with at least one guide collar, a shoe slidably coupled to the main housing in which a pipe is receivable having at least one guide pin that fits into the at least one guide collar to allow the main housing and shoe to slide relative to each other, a saw blade movable relative to the shoe, and a drive mechanism at least partially disposed within the main housing for driving the saw blade. The drive mechanism includes an electric motor, a bevel pinion driven by the electric motor, a compound gear including a bevel gear portion engaged with the bevel pinion and a spur gear portion coupled for co-rotation with the bevel gear portion, and an arbor shaft to which the saw blade is mounted. The arbor shaft includes an arbor gear and an idler gear engaged with both the spur gear portion and the arbor gear to transfer torque from the compound gear to the arbor shaft. The motor defines a motor axis that is parallel with a plane of the saw blade, and the arbor shaft defines an arbor axis that is perpendicular to the motor axis, and a gear ratio between the idler gear and the spur gear portion is at least 5:1.

The present invention provides, in yet another aspect, a circular saw plunge pipe cutter that includes a main housing, a drive mechanism at least partially disposed within the main housing, a saw blade operably coupled with the drive mechanism, and a shoe slidably coupled to the main housing. The shoe includes a shoe housing that fits around an upper portion of the main housing, a first portion that is fixed relative to the shoe housing, and a second portion that is movable relative to the shoe housing between a first state, in which the second portion is aligned with the first portion, and a second state, in which the second portion is misaligned with the first portion.

Other features and aspects of the disclosure will become apparent by consideration of the following detailed description and accompanying drawings.

### BRIEF DESCRIPTION OF THE DRAWINGS

FIG. 1 is a perspective view of a circular saw plunge pipe cutter.

FIG. 2 is left side view of the circular saw plunge pipe cutter of FIG. 1 with a portion of the housing removed.

FIG. 3 is a left side view of the circular saw plunge pipe cutter of FIG. 1 in a plunge cut state.

FIG. 4 is a top view of the circular saw plunge pipe cutter of FIG. 1.

FIG. 5 is a right side of the circular saw plunge pipe cutter of FIG. 1 with a blade guard assembly in an open state.

FIG. 6 is a perspective view of a drive mechanism of the circular saw plunge pipe cutter of FIG. 1.

FIG. 7 is top view of the drive mechanism of FIG. 6.

FIG. 8 is a perspective view of another aspect of a circular saw plunge pipe cutter.

FIG. 9 is a perspective view of yet another aspect of a circular saw plunge pipe cutter.

FIG. 10 is a perspective view of still another aspect of a circular saw plunge pipe cutter.

FIG. 11 is a perspective view of another aspect of a circular saw plunge pipe cutter.

FIG. 12 is a perspective view of yet still another aspect of a circular saw plunge pipe cutter.

FIG. 13 is a perspective view of still yet another aspect of a circular saw plunge pipe cutter.

Before any embodiments of the present disclosure are explained in detail, it is to be understood that the embodiments described herein are not limited in scope or application to the details of construction and the arrangement of components set forth in the following description or as illustrated in the following drawings. The devices described herein are capable of other embodiments and of being practiced or of being carried out in various ways. Also, it is to be understood that the phraseology and terminology used herein is for the purpose of description and should not be regarded as limiting.

### DETAILED DESCRIPTION

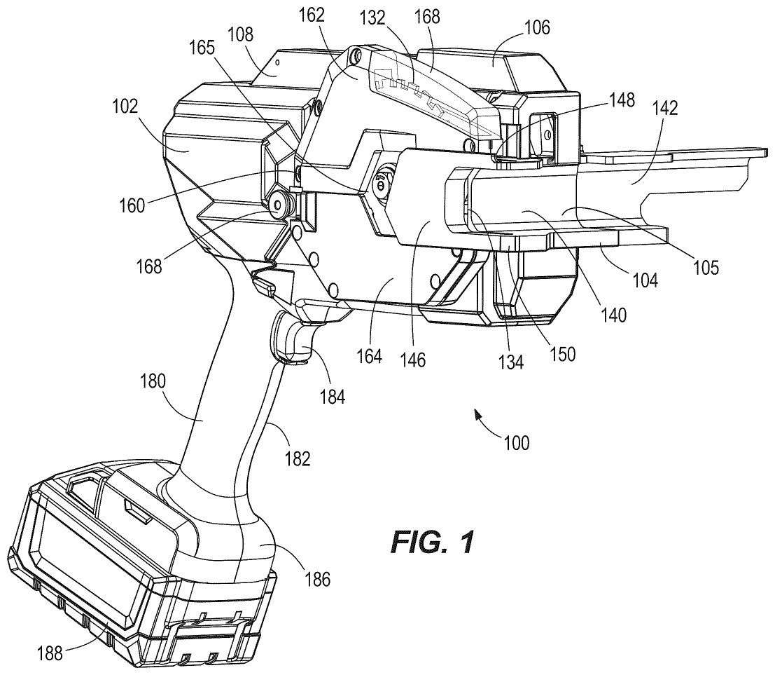

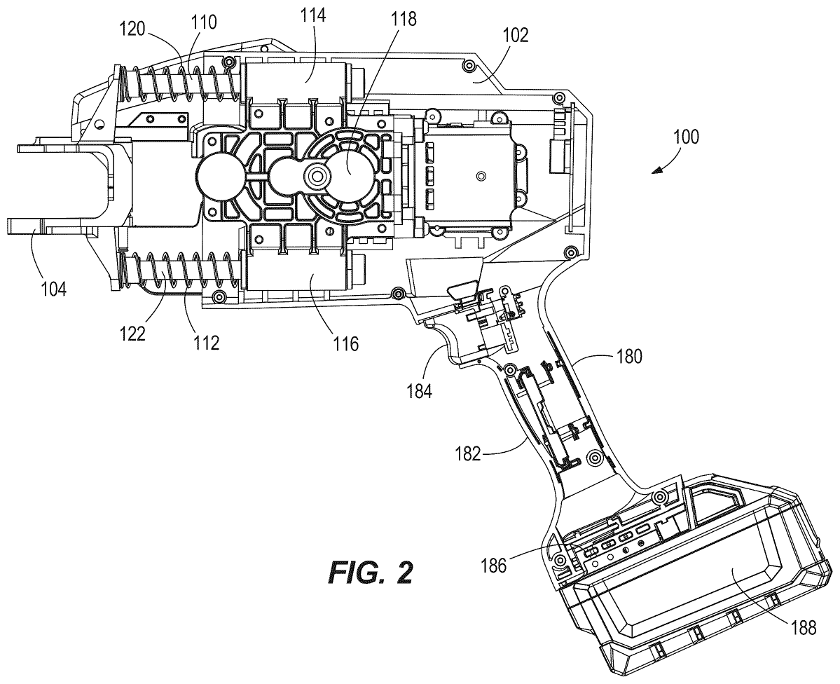

As shown in FIGS. 1-5, a circular saw plunge pipe cutter 100 includes a main housing 102 having a shoe 104 slidably mounted thereto. The shoe 104 includes generally U-shaped pipe receptacle 105 that is configured to fit around a pipe. Moreover, the shoe 104 includes a shoe housing 106 that is configured to fit around and slide relative to an upper portion 108 of the main housing 102. A first guide pin 110 and a second guide pin 112 extend from the shoe 104 and are slidably mounted within respective guide collars 114, 116 that extend from a guide plate 118. Each guide pin 110, 112 is surrounded by a spring 120, 122 to bias the shoe 104 away from the guide plate 118 and in turn, bias the shoe housing 106 away from the main housing 102. Each spring 120, 122 may be surrounded by a protective bellows (not shown) that expands and collapses as the shoe 104 moves relative to the main housing 102. The protective bellows prevents swarf from a cutting operation from potentially fouling the guide pins 110, 112 and guide collars 114, 116 and making it difficult for the shoe 104 to slide relative to the main housing 102. In another aspect, each guide collar 114, 116 or the guide plate 118 may include a grease fitting (e.g., a grease zerk) leading to each guide pin 110, 112. As such, grease may be injected around each guide pin 110, 112 to clear out any swarf that infiltrates the interface between the guide pin 110, 112 and guide collar 114, 116.

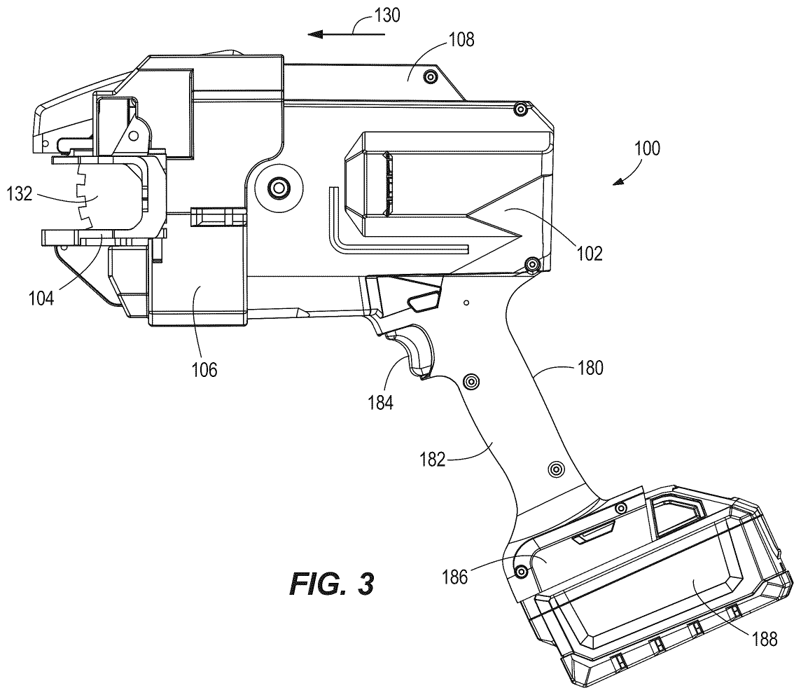

As shown in FIG. 3, when the main housing 102 slides into the shoe housing 106 toward the shoe 104, in a plunge direction 130, a circular saw blade 132 passes through a saw blade slot 134 (FIG. 1) formed laterally through the shoe 104. This allows a user to place the shoe 104 around a pipe (not show) and while the saw blade 132 is rotating, slowly move the main housing 102 toward the shoe 104 against the biasing force of the springs 120, 122 to move the saw blade 132 through the shoe 104 to perform a cutting operation on the pipe. Accordingly, the circular saw plunge pipe cutter 100 is movable between a plunge state in which the main housing 102 moves toward the shoe 104 and the saw blade 132 extends through the saw blade slot 134 in the shoe 104 into the pipe receptacle 105 and a retracted state in which the main housing 102 moves away from the shoe 104 and the saw blade 132 is clear of the pipe receptacle 105.

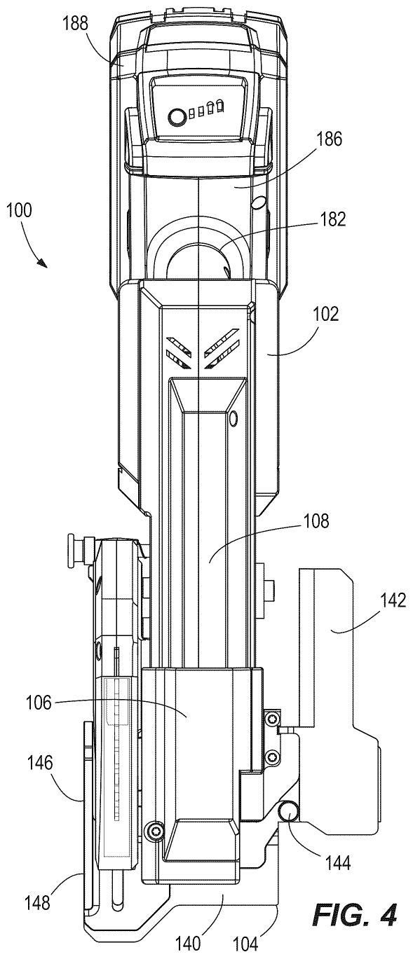

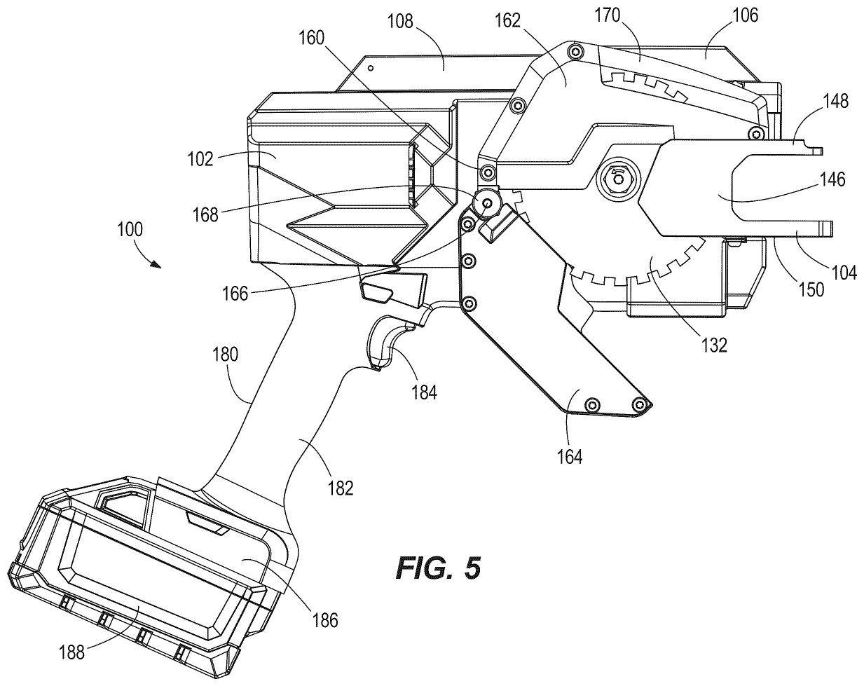

FIG. 4 shows that the shoe 104 includes a first portion 140 and a second portion 142. The first portion 140 is fixed relative to the shoe housing 106 and the second portion 142 is selectively movable relative to the shoe housing 106. The second portion 142 provides additional pipe support to ensure a straight cut through a pipe. The second portion 142 is movable between a first state in which it is aligned with the first portion 140 of the shoe 104, as shown in FIG. 1, and a second state in which it is misaligned with the first portion 140. For example, the second portion 142 is rotated away from the first portion 140 about a pin 144, as shown in FIG. 4, for storage or for a cutting operation with limited space. It is to be understood that the pin 144 may also be removed to allow the second portion 142 to be removed completely from the shoe 104. In another aspect, the second portion 142 may telescope into the first portion 140. As shown, the shoe 104 also includes an end plate 146 that includes an upper guide rail 148 and a lower guide rail 150 (FIG. 5) formed along a blade guard (discussed below). The end plate 146 and the guide rails 148, 150 provide additional rigidity and stability for the shoe 104 and protect the blade guard from being damaged if the circular saw plunge pipe cutter 100 is dropped.

As shown in FIG. 5, the circular saw plunge pipe cutter 100 also includes a blade guard 160 that fits around the saw blade 132 and very closely around the shoe 104 and slides relative to the shoe 104 during a cutting operation. Specifically, the blade guard 160 moves with the saw blade 132 as it moves into the saw blade slot 134 in the shoe 104. The blade guard 160 includes a fixed upper portion 162 and a rotating lower portion 164. A shoe slot 165 (FIG. 1) that is sized and shaped to closely fit around the outer periphery of the shoe 104 is formed between the upper portion 162 and lower portion 164 of the blade guard. As shown, the rotating lower portion 164 rotates about a pin 166 that includes a threaded thumb lock 168 that is tightened to prevent the lower portion 164 from rotating during a cutting operation. The thumb lock 168 is loosened to allow the lower portion 164 to be rotated away from the fixed upper portion 162 to allow the blade 132 to be removed/replaced and to dump swarf that collects in the blade guard 160 during a cutting operation. The fixed upper portion 162 further includes a transparent portion 170 to facilitate alignment of the saw blade 132 with a cut line on a pipe.

As further illustrated in FIGS. 1-5, the circular saw plunge pipe cutter 100 includes a lower housing portion 180 that includes a handle 182 with a trigger 184 and a battery receptacle 186 that is configured to receive a removable battery pack 188. The battery pack 188 may be configured having any of a number of different voltages (e.g., 12, 14.4, 18, 24, 28 volts, etc.) and may also be configured having any of a number of different chemistries (e.g., Lithium-ion, Nickel Cadmium, Nickel Metal-Hydride, etc.).

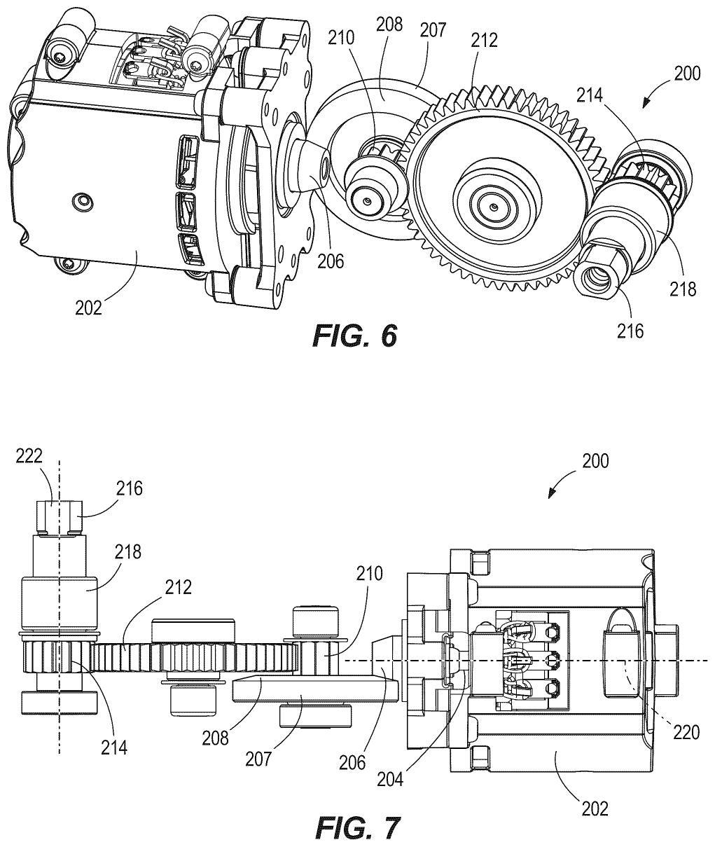

FIGS. 6 and 7 illustrate the drive mechanism 200 that is disposed in the upper portion 108 of the main housing 102 and operably coupled to the saw blade 132 to drive the saw blade 132. The drive mechanism 200 includes a motor 202 that includes and output shaft 204. In a particular aspect, the motor 202 is a brushless direct-current (“BLDC”) motor. A bevel gear pinion 206 is mounted on the output shaft 204 and is engaged with a compound gear 207 having a bevel gear portion 208 and a spur gear portion 210. The bevel gear portion 208 is driven by the bevel gear pinion 206 while the spur gear portion 210 of the compound gear 207 is engaged with, and drives, a large idler gear 212. The large idler gear 212, in turn, is engaged with, and drives, a small arbor gear 214 mounted on the arbor shaft 216. The gear ratio between the bevel gear portion 208 and the bevel gear pinion 206 is greater than 2.5:1 and less than or equal to 5:1. More specifically, the gear ratio between the bevel gear portion 208 and the bevel gear pinion 206 is approximately 3.25:1. The gear ratio between the large idler gear 212 and the spur gear portion 210 on the compound gear 207 is greater than or equal to 5:1 and less than or equal to 7:1. Moreover, the gear ratio between the large idler gear 212 and the spur gear portion 210 on the compound gear 207 is approximately 5.4:1. The ratio between the small arbor gear 214 and the large idler gear 212 is greater than or equal to 0.25:1 and less than or equal to 0.45:1. Specifically, the ratio between the small arbor gear 214 and the large idler gear 212 is approximately 0.32:1.

The arbor shaft 216 is mounted on a needle bearing 218. As shown, the output shaft 204 of the motor 202 defines, or otherwise rotates about, a motor axis 220 that is parallel with the plunge direction 130 (FIG. 3) of the circular saw plunge pipe cutter 300 or the plane of the saw blade 132. The arbor shaft 216 defines, or rotates about, an arbor axis 222 that is perpendicular to the motor axis 220. This arrangement allows for a relatively slim profile for the circular saw plunge pipe cutter 100 in which the smallest blade possible is mounted on the circular saw plunge pipe cutter 100 for cutting one inch (1″) IPS pipe. The bevel gear portion 208 does most of the gear reduction and torque amplification. The circular saw plunge pipe cutter 100 may also include a fan driven by the motor 202 to blow swarf away from the guide pins 110, 112 and collars 114, 116 to prevent the swarf from clogging or fouling the guide pins 110, 112, and collars 114, 116.

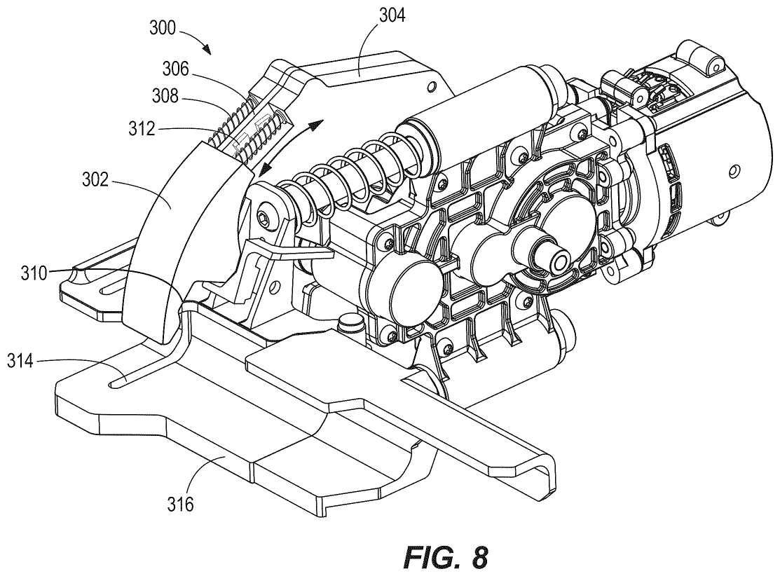

FIG. 8 illustrates another aspect of a circular saw plunge pipe cutter 300 that includes a pipe clamp 302 rotatably, and/or slidably, disposed on the blade guard 304. For example, the pipe clamp 302 includes a sliding portion 306 that is biased outward by one or more springs 308 to rotate a clamp portion 310 further around a pipe as the saw blade 312 moves into the saw blade slot 314 formed in the shoe 316 during a cutting operation.

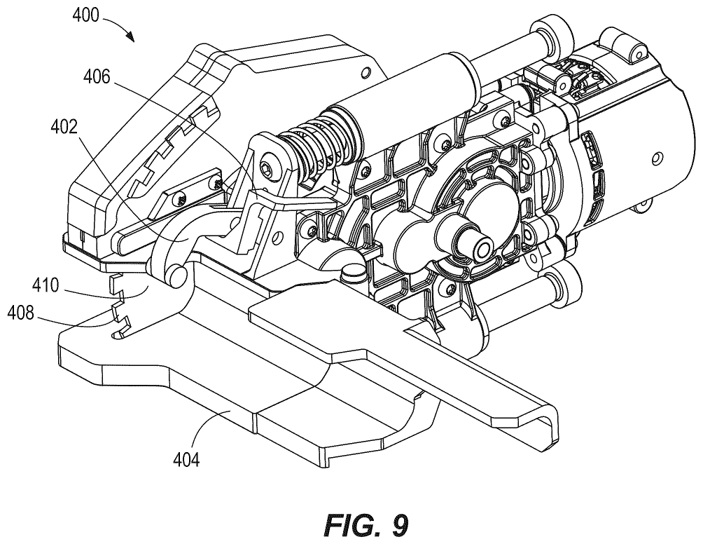

FIG. 9 illustrates another aspect of a circular saw plunge pipe cutter 400 that includes a pipe clamp 402 rotatably, and/or slidably, disposed on the shoe 404. For example, the pipe clamp 402 may be rotated around a pipe and locked in place via a lever 406. Thus, the pipe is held tightly in the shoe 404 as the saw blade 408 moves into the saw blade slot 410 formed in the shoe 404 during a cutting operation.

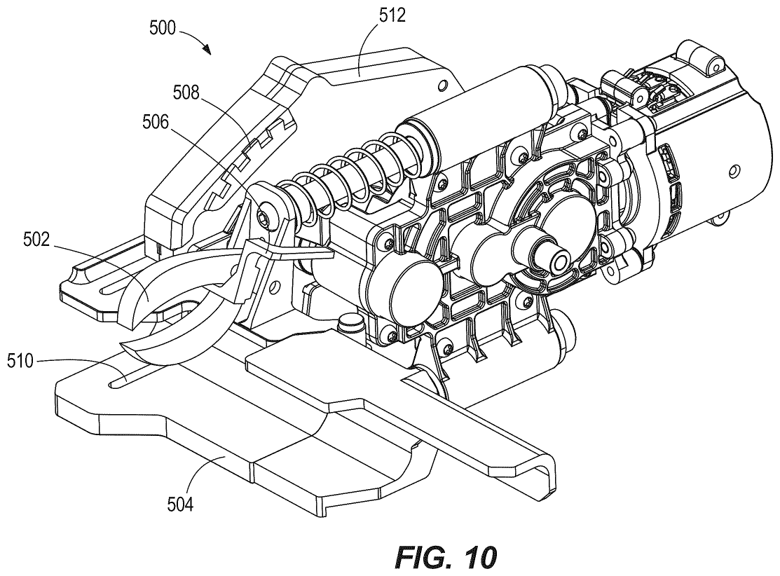

FIG. 10 illustrates another aspect of a circular saw plunge pipe cutter 500 that includes a scissor pipe clamp 502 rotatably, and/or slidably, disposed on the shoe 504. For example, the jaws of the scissor pipe clamp 502 may be rotated around a pipe and locked in place via a lever 506. Thus, the pipe is held tightly in the shoe 504 as the saw blade 508 moves into the saw blade slot 510 formed in the shoe 504 during a cutting operation. In another aspect, the scissor pipe clamp 502 may include a single jaw that is mounted on the blade guard 512.

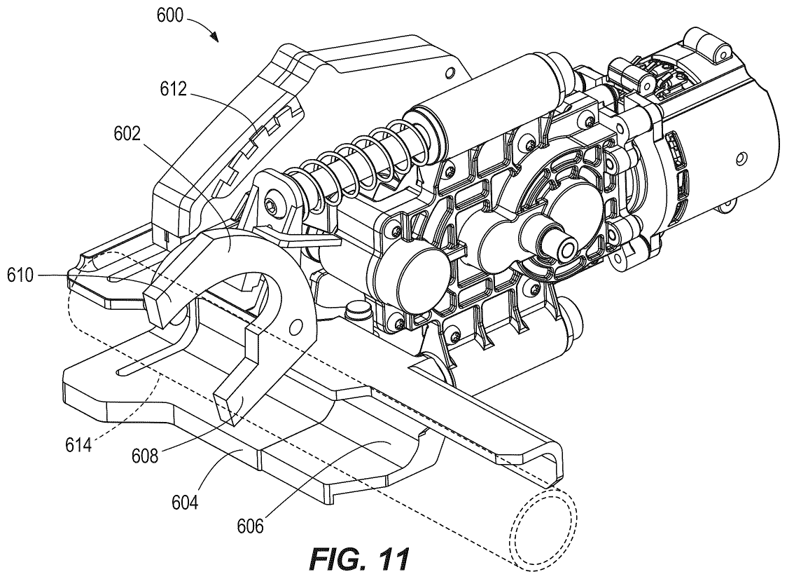

FIG. 11 illustrates another aspect of a circular saw plunge pipe cutter 600 that includes an over center cam pipe clamp 602 rotatably, and/or slidably, disposed on the shoe 604. For example, as a pipe 606 is moved into the shoe 604 the pipe 606 pushes against a lower portion 608 of the over center cam pipe clamp 602 which causes the over center cam pipe clamp 602 to rotate around the pipe 606 so that an upper portion 610 of the over center cam pipe clamp 602 grips the pipe 606 and holds the pipe 606 within the shoe 604. Thus, the pipe 606 is held tightly in the shoe 604 as the saw blade 612 moves into the saw blade slot 614 formed in the shoe 604 during a cutting operation.

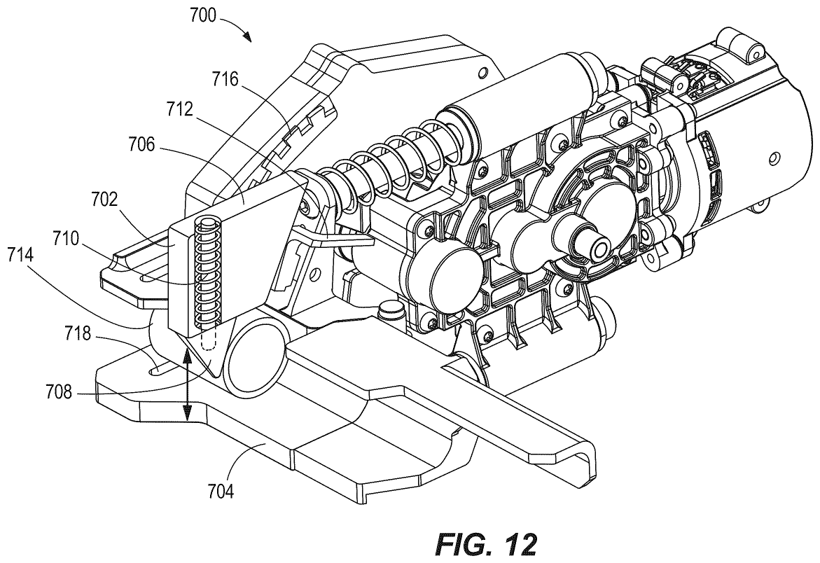

FIG. 12 illustrates another aspect of a circular saw plunge pipe cutter 700 that includes a pipe clamp 702 rotatably, and/or slidably, disposed on the shoe 704. The pipe clamp 702 includes a body 706 having a wedge 708 slidably disposed thereon. A spring 710 biases the wedge 708 toward the shoe 704. The pipe clamp 702 includes a locking lever 712 that is used to lock and release the pipe clamp 702. For example, when the pipe clamp 702 is moved into a locking state adjacent the shoe 704, as shown in FIG. 12, the circular saw plunge pipe cutter 700 is moved against a pipe 714 to bias the wedge 708 toward the body 706 of the pipe clamp 702 until the pipe 714 clears the wedge 708 and the spring 710 biases the wedge 708 toward the shoe 704 to lock the pipe 714 within the shoe 704. Thus, the pipe 714 is held tightly in the shoe 704 as the saw blade 716 moves into the saw blade slot 718 formed in the shoe 704 during a cutting operation.

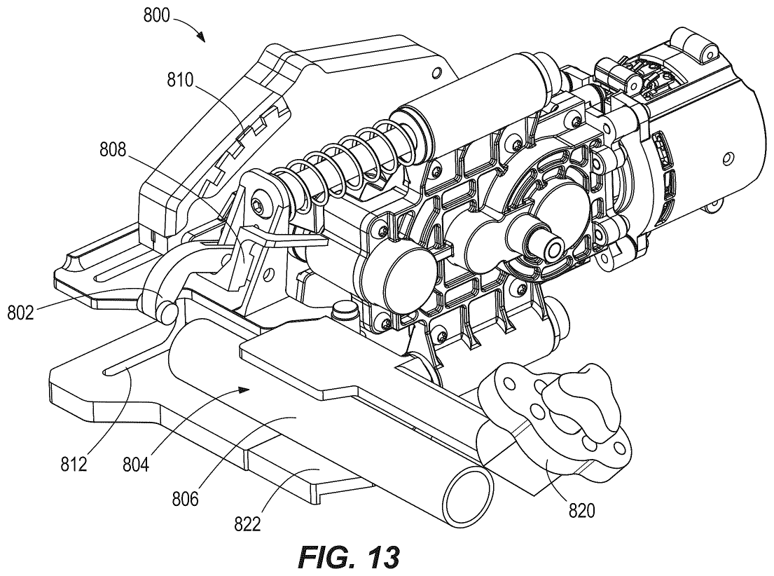

FIG. 13 illustrates another aspect of a circular saw plunge pipe cutter 800 that includes a pipe clamp 802 rotatably, and/or slidably, disposed on the shoe 804. For example, the pipe clamp 802 may be rotated around a pipe 806 and locked in place via a lever 808. Thus, the pipe 806 is held tightly in the shoe 804 as the saw blade 810 moves into the saw blade slot 812 formed in the shoe 804 during a cutting operation. The circular saw plunge pipe cutter 800 further includes an electromagnetic clamp 820 adjacent a wall 822 of the shoe 804, e.g., a back wall or a bottom wall. The electromagnetic clamp 820 may be activated when the circular saw plunge pipe cutter 800 is powered on and de-activated when the circular saw plunge pipe cutter 800 is powered off. In another aspect, the electromagnetic clamp 820 may also be used for attracting and holding ferromagnetic swarf. The electromagnetic clamp 820 may be turned off to release the ferromagnetic swarf.

Various features of the invention are set forth in the following claims.

What is claimed is:

1. A circular saw plunge pipe cutter comprising:
a main housing;
a drive mechanism at least partially disposed within the main housing;
a saw blade operably coupled with the drive mechanism; and
a shoe slidably coupled to the main housing, wherein the shoe includes a pipe receptacle in which a pipe is receivable;
wherein the circular saw plunge pipe cutter is adjustable between a plunge state in which the main housing moves toward the shoe and the saw blade extends into the pipe receptacle, and a retracted state in which the main housing moves away from the shoe and the saw blade does not extend into the pipe receptacle.

2. The circular saw plunge pipe cutter of claim 1, wherein the main housing includes a guide plate disposed therein, and wherein the guide plate includes at least one guide collar.

3. The circular saw plunge pipe cutter of claim 2, wherein the shoe includes at least one guide pin that fits into the at least one guide collar, and wherein the at least one guide pin allows the main housing and shoe to slide relative to each other.

4. The circular saw plunge pipe cutter of claim 3, wherein the shoe includes a shoe housing that fits around an upper portion of the main housing, and wherein the shoe housing slides over the upper portion of the main housing during a cutting operation.

5. The circular saw plunge pipe cutter of claim 4, wherein the shoe includes a first portion that is fixed and a second portion that is movable between a first state, in which the second portion is aligned with the first portion, and a second state in which the second portion is misaligned with the first portion.

6. The circular saw plunge pipe cutter of claim 5, wherein in the second state, the second portion is rotated away from the first portion about a pin.

7. The circular saw plunge pipe cutter of claim 5, wherein in the second state, the second portion is removed from the shoe and moved away from the first portion.

8. The circular saw plunge pipe cutter of claim 1, further comprising a blade guard mounted on the main housing around the saw blade.

9. The circular saw plunge pipe cutter of claim 8, wherein the blade guard includes an upper portion and a lower portion that rotates with respect to the upper portion.

10. The circular saw plunge pipe cutter of claim 9, wherein the blade guard further includes a shoe slot formed between the upper portion and a lower portion of the blade guard, and wherein the shoe slot is sized and shaped to closely fit around an outer periphery of the shoe.

11. The circular saw plunge pipe cutter of claim 1, wherein the shoe includes a saw blade slot adjacent the pipe receptacle.

12. The circular saw plunge pipe cutter of claim 11, wherein when the circular saw plunge pipe cutter is in the plunge state, the saw blade extends through the saw blade slot and into the pipe receptacle.

13. A circular saw plunge pipe cutter comprising:
a main housing including a guide plate having at least one guide collar;
a shoe slidably coupled to the main housing in which a pipe is receivable, the shoe includes at least one guide pin that fits into the at least one guide collar to allow the main housing and shoe to slide relative to each other;
a saw blade movable relative to the shoe; and
a drive mechanism at least partially disposed within the main housing for driving the saw blade, wherein the drive mechanism includes:
an electric motor;
a bevel pinion driven by the electric motor;
a compound gear including a bevel gear portion engaged with the bevel pinion and a spur gear portion coupled for co-rotation with the bevel gear portion;
an arbor shaft to which the saw blade is mounted, the arbor shaft including an arbor gear; and
an idler gear engaged with both the spur gear portion and the arbor gear to transfer torque from the compound gear to the arbor shaft; and
wherein the electric motor defines a motor axis that is parallel with a plane of the saw blade, and wherein the arbor shaft defines an arbor axis that is perpendicular to the motor axis, and
wherein a gear ratio between the idler gear and the spur gear portion is at least 5:1.

14. The circular saw plunge pipe cutter of claim 13, wherein the electric motor is disposed in a rear portion of the main housing.

15. The circular saw plunge pipe cutter of claim 13, wherein the saw blade is movable in a plunge direction that is parallel to the motor axis.

16. A circular saw plunge pipe cutter comprising:
a main housing;
a drive mechanism at least partially disposed within the main housing;
a saw blade operably coupled with the drive mechanism; and
a shoe slidably coupled to the main housing, wherein the shoe includes a shoe housing that fits around an upper portion of the main housing, and
wherein the shoe includes a first portion that is fixed relative to the shoe housing and a second portion that is movable relative to the shoe housing between a first state, in which the second portion is aligned with the first portion, and a second state, in which the second portion is misaligned with the first portion.

17. The circular saw plunge pipe cutter of claim 16, wherein in the second state, the second portion is rotated away from the first portion about a pin.

18. The circular saw plunge pipe cutter of claim 16, wherein the shoe includes a pipe receptacle in which a pipe is receivable.

19. The circular saw plunge pipe cutter of claim 18, further comprising a clamp for rotatably constraining the pipe within the pipe receptacle during a cutting operation.

20. The circular saw plunge pipe cutter of claim 16, further comprising a blade guard mounted on the main housing around the saw blade, wherein the blade guard includes an upper portion and a lower portion that rotates with respect to the upper portion.
